(19) United States
(12) Patent Application Publication
(10) Pub. No.: US 2006/0243385 A1
(43) Pub. Date: Nov. 2, 2006

(54) Device for producing electroconductive passages in a semiconductor wafer by means of thermomigration

(75) Inventors: Frank Kudella, Berlin (DE); Roland Reetz, Berlin (DE); Marko Enßlen, Berlin (DE); Mario Rasel, Berlin (DE); Karsten Schindel, Berlin (DE); Bernd Kriegel, Berlin (DE)

Correspondence Address: CHRISTIE, PARKER & HALE, LLP, PO BOX 7068, PASADENA, CA, 91109-7068, US

(73) Assignees: HTM REETZ GMBH, Berlin (DE); SILCON SENSOR GMBH, Berlin (DE)

(21) Appl. No.: 10/542,662

(22) PCT Filed: Jan. 20, 2004
(86) PCT No.: PCT/DE04/00069

§ 371 Date: Apr. 25, 2006

(30) Foreign Application Priority Data
Jan. 20, 2003 (DE) 103 02 653.3

(51) Int. Cl. C09J 5/02

(52) U.S. Cl. 156/307.3

(57) ABSTRACT

A device for producing electroconductive passages in a semi-conductor wafer, by thermomigration, by producing a temperature gradient between the surfaces of the semiconductor wafer which is arranged in a recipient closed in a vacuum-tight manner and containing a good heat-conductive gas, between an inductively heated susceptor used as a heat source, and a heat sink through which a cooling medium flows, and by applying a doping substance to the surface of the semiconductor wafer facing the heat sink. The susceptor is connected to the heat sink which is arranged in such a way that it can be rotated, together with the susceptor. In the event of high purity requirements, the recipient is divided into two gas volumes which are separated from each other in a gastight manner, one gas volume consisting of a processing chamber receiving the susceptor, and the other gas volume consisting of an inductor chamber receiving the inductor.

### CROSS-REFERENCE TO RELATED APPLICATION

This application is a National Phase Patent Application of International Application Number PCT/DE2004/000069, filed on Jan. 20, 2004, which claims priority of German Patent Application Number 103 02 653.3, filed on Jan. 20, 2003.

### BACKGROUND

The invention relates to a device for producing electroconductive passages in a semi-conductive wafer by thermomigration.

The thermomigration process, also called temperature-gradient-zone melting-process (TGZM process), especially that of aluminium into silicon is a special doping process by which it is possible to produce in n-conducting silicon p-conducting, aluminium-doped ducts, lines or frames which connect the opposing surfaces of semiconductor bodies, more particularly of a semiconductor wafer, together. A process of this kind is described by way of example in U.S. Pat. No. 3,897,277 to Blumenfield, or U.S. Pat. Nos. 3,901,736; 3,910,801; 3,898,106; 3,902,925; 3,899,361 to Anthony and Cline, and in WO 83/03710 by Brown.

With this type of process when the temperature is sufficient a metal layer which was initially applied in solid form locally on the semiconductor wafer migrates as a fluid zone along a temperature gradient through the semiconductor wafer and leaves behind in the semiconductor material a trace doped to the level of the solubility concentration of the metal at the processing temperature. This patent describes a particularly suitable device for carrying out a thermomigration process of this kind.

For a thermomigration process a silicon wafer is provided for example in a device which consists of a heat source and heat sink between which the silicon wafer which is to be treated is introduced. A heat current flows between the heat source and heat sink and also flows perpendicularly through the silicon wafer. As a result of the final heat conduction of the silicon a temperature difference and thus temperature gradient arises between the two wafer surfaces.

If the heat source and heat sink are in a vacuum then the energy flow takes place solely through the heat radiation mechanism. If a heat-conductive medium such as for example helium is introduced between the heat source and heat sink then the heat transfer can proceed more effectively through additional heat conduction. The silicon wafer is heated in the process up to 900 to 1300° C. If a suitable metal doping substance, for example aluminium for p-doping, is provided over the cooler surface of the silicon wafer then the metal doping substance migrates with the dissolved surrounding semiconductor material as a droplet of an expansion of few 10 μm as a result of the temperature gradient produced by heating one wafer side and cooling the other wafer side in the silicon wafer to the opposite warmer surface of the silicon wafer and produces a doped trace on the covered path.

Thermomigrated structures are used in the form of columns, ducts, line or frame structures for SMD component elements (surface mounted devices) in which the contact spots of the two electrodes can be arranged on one surface of the component so that the component can be attached with its back against a conductor plate provided with suitable contact surfaces without the need for additional wires or other connecting elements, in photodiode arrays, for electrical insulation of adjacent circuits in a chip (npn-back-to-back-diode isolation), for micro electromechanical systems (MEMS) and the like.

The use of a thermomigration process requires for building up an intensive heat stream and thus a temperature gradient of typically 20 to 100 K/cm in silicon a lateral homogeneous heating of one wafer side of the prepared semiconductor wafer to about 900° C. to 1300° C. and at the same time an effective likewise lateral homogeneous cooling of the other wafer side.

From WO 83/03710 a method is known for carrying out a thermomigration process on semiconductors in which the suitably prepared semiconductor is placed with the one surface on a substantially flat surface area of a heat source. The semiconductor is heated up whereby a temperature difference is built up between the two surfaces of the semiconductor. Drops of oppositely conducting material applied to the semiconductor thereby migrate through the semiconductor and form conductive connections between the two surfaces. The heating element is then cooled and the semiconductor removed. Through the direct contact between the semiconductor and heat source a high temperature gradient is produced in the semiconductor and thus the process is accelerated.

The device used for carrying out the process contains a disc like graphite susceptor for holding several silicon wafers which are to be migrated in milled indentations which is mounted in a recipient chamber with water-cooled jacket. The susceptor is mounted on a quartz ram which is connected to a rotational device guided through the recipient base. Heating up the susceptor is carried out inductively for which a surface inductor is located underneath the susceptor and is controlled by an RF power generator. The fixed heat sink in the form of a cooling top through which water flows is mounted tight above the susceptor and is evacuated at the beginning of the process cycle and in the following migration process helium flows through same at atmospheric pressure.

Since graphite is available in very pure qualities and has an extremely low steam pressure, in this arrangement the contamination problem is adequately solved for a series of uses. At the same time in this arrangement the heat source has a good lateral homogeneity and can thus be drawn up anywhere close to the silicon wafer. Instead of heat radiation the heat dissipation to the silicon wafer is carried out by means of heat conduction through direct contact between the graphite susceptor and the silicon wafer lying thereon. To transfer heat to the heat sink apart from heat radiation heat conduction is also used in gas as the transport mechanism which is assisted by using helium as the process gas. At the same time the distance between the heat sink and silicon wafer can be reduced within certain limits which increases the possibilities of influencing the temperature gradient in the process.

The drawbacks with the known device lie in the fact that the spacing between the cooling pot and surface of the silicon wafer for technical reasons cannot be any small amount since the two are moved opposite one another and are fixed on different apparatus components. Furthermore it is not possible to vary the gas pressure for controlling the heat transport between the silicon wafer and cooling.

### SUMMARY

The object of the present invention is to provide a device for the thermomigration of the type mentioned at the beginning which guarantees a homogeneous effective heating and cooling of semiconductor wafers which can be set independently of each other, which enables simultaneous treating of several semiconductor wafers with minimum processing time, which meets the purity demands of semiconductor technology, is particularly suitable for treating high ohmic silicon, has a low energy consumption, a minimal heat resistance between heat sink and wafer surface controllable through the process gas pressure and spacing, as well as enables an automatic processing sequence and a high technical availability with reproducible processing.

The device according to the invention guarantees for manufacturing electroconductive passages in a semiconductor wafer by means of thermomigration a homogeneous effective heating and cooling of the semiconductor wafer which can be set substantially independent of each other, enables the simultaneous treating of several semiconductor wafers with minimal processing time, meets the purity demands of semiconductor technology, is particularly suitable for treating high ohmic silicon, has a low energy consumption as well as minimum heat resistance between heat sink and wafer surface which can be controlled through the process gas pressure and distance, and enables an automatic process sequence and a high technical availability with reproducible processing.

These advantages are achieved in particular in that the distance between the underneath of the heat sink and top of the semiconductor wafer can be lowered to a measurement which depends only on the quality of the surfaces and with the currently standard manufacturing precisions lies in the region of some few tenths millimeter. Thus even with susceptors having large diameters of 400 to 700 mm which are the pre-requirement for the simultaneous treatment of several semiconductor wafers with minimal processing time, very small distances can be set between the heat sink and susceptor surface which can be produced and without canting and which also remain unchanged during the rotation of the susceptor.

Furthermore coupling the susceptor to the heat sink and its inductive heating is a pre-requirement for a low-contamination processing chamber. The joint rotation of the susceptor and the heat sink at about 30 to 50 revolutions per minute eliminates circular temperature differences and thus ensures uniform heating through the or each semiconductor wafer.

The susceptor is preferably resiliently pretensioned in the direction of the heat sink and spacers are arranged between the heat sink and susceptor or a support holding the susceptor.

A force thereby acts constantly on the susceptor to try and reduce the gap between the heat sink and wafer surface whereby the exact distance between the underneath of the heat sink and wafer surface can be set with the spacers.

In a preferred embodiment the heat sink consists of a rotationally symmetrical cooling pot with a circular disc shaped or circular ring shaped base facing the wafer surface whereby the cooling pot is guided vacuum-sealed and rotatable through an opening in the recipient, and in its part projecting out from the recipient has at least a cylindrical section through which the cooling medium is supplied and discharged, and a pipe separate from the cooling medium, for supplying the good heat conductive process gas.

By dividing the recipient into two gas chambers separated gas-tight from each other and of which one gas chamber consists of a processing chamber holding the susceptor and the other gas chamber consists of an inductor chamber holding the inductor, the processing chamber with the susceptor and semi conductor wafer is protected from possible heavy metal contamination which can be given off particularly in the form of copper and gold by the inductor serving for the inductive heating of the susceptor, enables the selection of an electrically specially voltage-proof and flashover-proof gas atmosphere at the inductor as well as a different gas pressure in the processing chamber and in the inductor chamber and also a pressure lying below atmospheric pressure, and ensures an effective laminar inert gas purging between susceptor and heat sink with low gas consumption through helium as the process gas in the rough vacuum region.

Consequently the processing chamber is preferably filled with good heat conductive process gas, more particularly helium which circulates round the surface of the wafer in a laminar flow, and the inductor chamber is filled with a gas of high dielectric or disruptive strength, by way of example with dry nitrogen, SF₆ or a mixture of both gases, and different gas pressures which can be regulated independent of each other are set selectively in the processing and inductor chambers.

Furthermore the thermomigration device can be evacuated or heated without changing the set distances between the surfaces of the heat sink and the susceptor.

The inductor chamber is divided gas-tight from the processing chamber by an electrically isolating vessel connected to the recipient base, more particularly a vessel, preferably a quartz bell, which is transparent at least in some areas of its surface.

In a preferred embodiment the recipient consists of an upper part holding the susceptor and the heat sink (also called cooling pot), and a lower part connected to the base surface of the recipient and enclosing the inductor and/or the at least partially transparent vessel containing the inductor.

To make it easier to load the thermomigration device with semi conductor wafers as well as to remove the finished semiconductor wafer the upper part which is connected to the heat sink/cooling pot and to the susceptor can be removed, lifted off and pivoted away from the lower part.

Since different demands are placed on the purity requirements in the case of thermomigration depending on the field of use, with few critical contamination or lower purity demands it is possible to omit the separation of the processing and inductor chambers and thus the gas-tight quartz bell and the technically expensive pressure regulating system between the two separate gas volumes. The omission of the gas-tight quartz bell with a thickness of about 10 to 15 mm additionally enables a reduction in the distance between the susceptor and the inductor which leads to an increase in the efficiency of the inductive heating device since a lower reactive power is used in the inductor vibration circuit for the same induced power in the susceptor.

In addition the lateral temperature homogeneity of the susceptor is improved as a result of the omission of the unavoidable thermal coupling of the upper side of the quartz bell to the geometrically close susceptor underneath and the thereby conditioned reduced thermal inertia which with two separate gas chambers is noticeably disruptive in particular in the heating-up phase of the susceptor primarily through the heat conduction through the helium gas layer between the susceptor and the quartz bell.

Owing to the detachable connection between susceptor and heat sink however the significant advantage of being able to make defined adjustment of small distances between the susceptor and the heat sink remains, even with large diameters, more particularly to produce particularly high temperature gradients of several 100 K/cm in silicon.

In a further embodiment of the invention the temperature of the outside edge of the susceptor is lower than its inside surface which holds the semiconductor wafer and the outside edge of the susceptor is detachably connected to a socket section of the cooling pot mounted in the edge region of the circular disc shaped or circular ring shaped cooling pot base.

Preferably there is between the outside edge of the susceptor and the inside face of the susceptor holding the semiconductor wafer a section which reduces the heat flow from the inside face to the outside edge and preferably consists of several narrow webs, indentations or the like. The narrow webs and indentations thereby restrict the heat flow between the central hot region of the inside face of the susceptor in which the semiconductor wafers are located, and the colder outside edge so that the connecting means between the susceptor and the heat sink are not exposed to any increased thermal strains.

Indeed the thermal separation of the outside edge from the inside face enables a rapid slope which is advantageous for the thermomigration process as well as a greater homogeneity with the heat distribution since otherwise a considerable proportion of the heat generated in the susceptor would be discharged over the outer edge. The narrow long webs at the same time prevent the build up of mechanical tensions owing to the temperature difference between the contact bearing area of the semiconductor wafer on the inside face and the outside edge.

So that as little power as possible is induced into the outside edge of the susceptor which is thermally decoupled from the inner part of the susceptor, the outside edge of the susceptor has preferably a larger vertical distance from the inductor than its inside face which holds the semiconductor wafer.

The angle of the outside edge serves to increase the distance from the intensely heated inside face to the edge of the susceptor so that the thermal strain of the fixing elements for connecting the susceptor to the heat sink is further reduced and the fixing elements can be arranged in a region of the susceptor which lies outside of the field discharged by the inductor so that the distance between the susceptor and inductor can be minimized.

Alternatively instead of a dish or plate shaped susceptor it is also possible to use a disc shaped susceptor which is connected to the heat sink through the outer circular disc shaped edge. Also with this flat geometric shape of the susceptor outer and inner regions are preferably only connected together through long narrow webs. This geometric shape does indeed condition a greater distance to the inductor but enables the production of a very simple shaped susceptor. This configuration of the susceptor is particularly suitable for a simplified embodiment of the thermomigration device in which the separation of the gas volumes is omitted and owing to the absence of the quartz bell a smaller distance can be set from the inductor without problems when connecting the susceptor to the heat sink.

For precision setting the distance between the surface of the semiconductor wafer or susceptor and the heat sink or cooling pot base it is possible to provide between the base surface of the cooling pot and the outer edge and/or the inner face of the susceptor, spacers, preferably designed as quartz glass cylinders made of a high temperature resistant electrically insulating material of low heat conduction and high temperature shock resistance which are placed as cylindrical rods, tubes or flat discs on the surface of the susceptor. Alternatively it is possible to provide between the surface of the backing of the susceptor and the base surface of the cooling pot, spacers positioned in clearances in the outer edge of the susceptor.

In order to reduce the risk of contaminating steam evaporating from the cooling pot surface the latter is passivated through a passivating coating by way of example with titanium nitride, DLC (diamond-type carbon) or silicon carbide so that there is no risk of impurities on the semiconductor wafer mounted on the susceptor.

For the same reasons it is also possible to coat the susceptor surface with a thin passivating layer, preferably of SiC, Al₂O₃, TiN or DLC. Passivating layers on the susceptor surface also reduce the risk of the semiconductor wafer baking on the susceptor surface at the end of the thermomigration process as a reactive AlSi-melt. As a further separating medium between the susceptor surface and semiconductor surface it is possible to use very thin spacers, for example fibers of quartz glass with a length of 5 to 15 mm and a thickness of 10 to about 50 μm. In addition to a reliable separation between the susceptor and wafer surfaces they also produce a homogeneous heat transfer over the entire surface of the semiconductor wafer to the susceptor surface, by means of the separating thin gas layer of helium.

In order to optimize the cooling of the cooling pot base and to minimize the heat resistance of the cooling pot base the cooling pot has shades, partitions and/or reinforcement ribs and the cooling medium is introduced into the part of the cooling pot projecting out from the recipient, guided round the rotational axis of the cooling pot to the centre of the surface of the circular disc or circular ring shaped cooling pot base remote from the susceptor, along this surface to the outside edge thereof and back to the part of the cooling pot projecting out from the recipient and discharged there whereby on the surface of the circular disc or circular ring shaped cooling pot base remote from the recipient there are several ducts whose number increases with an increasing radius whilst the cross-section of each individual duct thereby reduces, and the thickness of the cooling pot base decreases from inside outwards.

The vertical distance between the inner region of the cooling pot base underneath which there is no semiconductor wafer, and the plane of the wafer surface is preferably greater than the distance between the sections of the cooling pot base which are opposite the semiconductor wafer, and the wafer surface whereby the distance lies in the centimeter range.

The inductor consists of a spiral shaped or meander shaped tube, preferably of copper with a thick gilt-edged surface as surface inductor whereby the inductor leads are guided through an electrically insulated passage through the recipient base.

The individual windings of the spiral or meander shaped inductor are adjustable in relation to their distance from the susceptor so that by carefully adjusting these distances from the susceptor a radially very homogeneous temperature profile can be set.

The connecting elements connecting the susceptor to the cooling pot have springs which generate a force attracting the susceptor towards the cooling pot base whereby the connecting elements engage on one side on the outside edge and/or backing of the susceptor and on the socket section of the cooling pot.

The force generated by the springs is preferably taken up by simple shaped bodies or length-adjustable structural groups which are located between the cooling pot and susceptor or backing of the susceptor, and with their length determine the distance between the surface of the semiconductor wafer lying on the susceptor and the opposite sections of the base surface of the cooling pot.

The open inner region of the susceptor is covered by a disc of insulating material, more particularly quartz so that the process gas can only flow outwards through the gap between the semiconductor wafer and the cooling pot. The base of the cooling pot is drawn back, i.e. drawn away from the inductor over the open centre of the susceptor.

In a preferred embodiment of the invention the heat flow between the susceptor and the heat sink is measured through the product of the temperature difference of the cooling medium flowing in and out of the cooling pot, multiplied with its volume flow and its specific heat capacity. From determining the heat flow it is then possible to determine and adjust the relevant setting of the distance between the cooling pot and susceptor or distances between cooling pot, susceptor and/or inductor as well as the pressure in the recipient.

### BRIEF DESCRIPTION OF THE DRAWINGS

Further advantages and features of the invention are apparent from the following description of embodiments of the invention illustrated in the drawings explained in detail with reference to the drawings. They show:

FIG. 1 a schematic diagram of a device with a susceptor fixed on a heat sink and with two separate gas volumes;

FIG. 2 a schematic diagram of the pressure and gas regulation in the device according to FIG. 1;

FIG. 3 a schematic diagram of the pressure and gas regulation in a device having a susceptor fixed on the heat sink, and a gas volume;

FIG. 4 a detailed longitudinal sectional view through a first embodiment of a thermomigration device according to the invention;

FIG. 5 an enlarged view of the detail IV in FIG. 4;

FIG. 6 a partial sectional view through a second embodiment of a thermomigration device according to the invention;

FIGS. 7/8 enlarged views of the details VII and VIII according to FIG. 6, and

FIGS. 9-11 different views of a graphite susceptor used in the thermomigration devices according to FIGS. 4 and 6.

### DETAILED DESCRIPTION

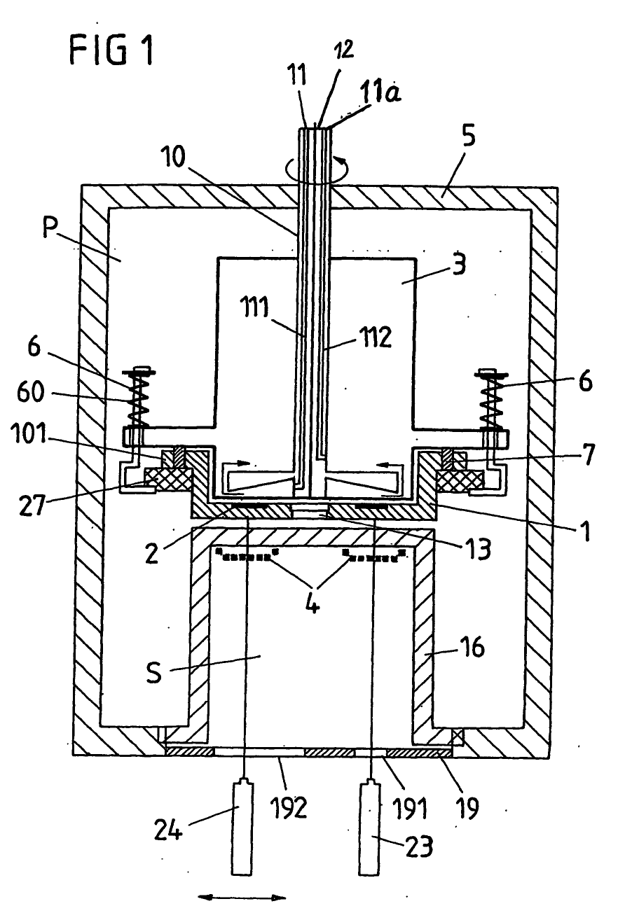

FIG. 1 shows a schematic diagram of a thermomigration device designed according to the invention in which a cooling pot 3 serving as a heat sink is located in a recipient 5 with water-cooled jacket wherein a graphite susceptor 1 provided with several milled wafer troughs with semiconductor wafers 2 mounted therein is hung from the cooling pot. The outside edge 101 of the susceptor 1 lies on a quartz support ring 27 which is drawn through spring-tensioned connecting elements 6 towards the base of the cooling pot 3. Through several spread-out cylindrical spacers 7, preferably of quartz glass, depending on the desired heat flow between the semiconductor wafer 2 and the cooling pot 3 or the heat sink the distance between the upper side of the susceptor 1 and thus the upper side of the semiconductor wafer 2 lying on the susceptor 1 on the one hand and the base of the cooling pot 3 on the other is set in the range from 0.5 to 5.0 mm very accurately and homogeneously over a large diameter of for example 450 mm.

The susceptor 1 is heated up inductively with an inductor 4 mounted at a distance of preferably less than 20 mm underneath the susceptor 1 through vortex flows which are fed by a controllable MF generator with a working frequency of preferably 15 to 50 kHz and for example a maximum power of about 100 kW for a susceptor with a diameter of about 450 mm. Typical processing temperatures of the thermomigration device shown diagrammatically in FIG. 1 lie in the range between 1000° C. and 1270° C.

For measuring the temperature two pyrometers 23, 24 are used with which the temperature on the underneath of the susceptor 1 is measured through measuring windows 191, 192 in the base 19 of a gas-tight quartz bell 16 holding the inductor 4. The measuring beam path of the pyrometer 23, 24 runs each time in a gap between two inductor windings.

The pyrometers 23, 24 are equipped with fine focus optics so that despite a spacing of the inductor windings of only some few millimeters it is possible to eliminate false readings through signal shadows. Whilst the pyrometer 23 is positioned stationary and supplies the measuring signal for the temperature control the pyrometer 24 is movable sideways and detects the radial temperature distribution of the susceptor 1.

The individual windings of the inductor 4 are adjustable in their spacing from the susceptor 1 so that by adjusting the distances between the windings of the inductor 4 it is possible to set a radially very homogeneous temperature profile on the susceptor 1. Circular temperature differences are eliminated through rotation at about 30 to 50 revolutions per minute of the structural assembly connected in the process and consisting of the susceptor 1 and cooling pot 3.

In order to discharge the heat flow from the heat sink an intensive flow of water is passed through the cooling pot 3. The discharged energy is determined by measuring the inflow and outflow temperature as well as the volume flow and the heat flow is determined in W/cm².

In the shaft 10 of the cooling pot 3 connected to a drive motor there is an isolated gas duct 12 for a process gas, preferably helium, directed into the recipient 5, and inflow and outflow ducts 111, 112 of a cooling liquid duct 11, for the inflow and outflow of the cooling medium water to the cooling pot 3.

In order to exclude the inductor 4 from being a source of contamination for the high temperature process it is mounted in an inductor chamber S isolated from the processing chamber P in the recipient 5. The separation into the processing chamber P and inductor chamber S is through the quartz bell 16 containing the inductor 4.

A further measure for increasing the semiconductor unit is lowering the helium working pressure during the process from atmospheric pressure to 30 to 150 mb. Convection flows in the processing chamber P are stopped and the heat resistance between the underneath of the cooling pot 3 and the surface of the semiconductor wafer 2 can be varied in the process with sufficiently low pressures without changing the distance whereby the setting of different pressures in the heating-up and migration phase have proved particularly advantageous. Furthermore with the same mass flow of process gas, residual gas traces are better removed through the constant pumping process and as a result of the higher speed of the laminar gas flow than through a purging gas flow at about 1000 mb.

Through the reduced working pressure and a voltage of more than 1.0 kV at the inductor 4 it is easy to arrive at gas discharges or flashovers in the inductor chamber S. Helium has a particularly unfavorable behavior in this respect so that no helium but dry nitrogen, SF₆ or a mixture of both gases is introduced in the inductor chamber S. The gas pressure can thereby be reduced owing to the higher disruptive strength of the nitrogen and/or SF₆ with regard to the load capacity of the quartz bell 16.

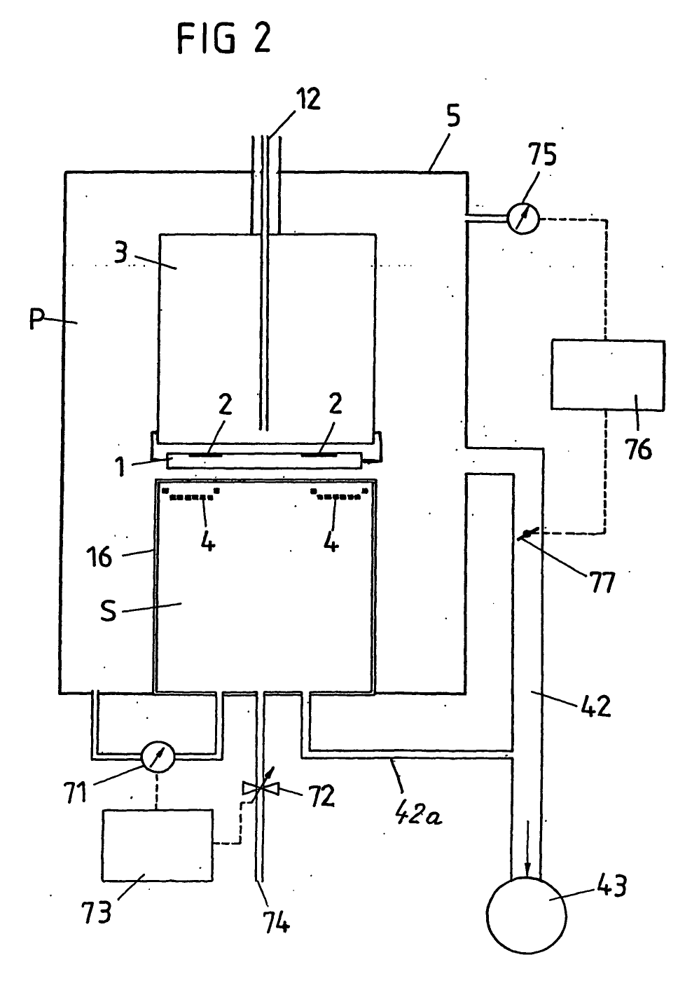

For this purpose the thermomigration device is provided according to FIG. 2 with a gas control. Helium gas is introduced into the processing chamber P through an inlet into the gas duct 12. The gas pressure in the processing chamber P is measured through a gas pressure sensor 75. A pressure regulator 76 with electronically controlled throttle valve 77 in a pump-out pipe 42 which leads to a vacuum pump 43 sets the gas pressure in the processing chamber P independently of the gas flow introduced.

In each operating state of the thermomigration device the differential pressure between the inductor chamber S and processing chamber P is monitored and the pressure in the inductor chamber S is regulated to a pressure which is higher by the predetermined differential pressure. To this end a differential pressure sensor 71 is mounted between the processing chamber P and the inductor chamber S and is connected to both gas chambers P and S. Together with a gas regulating valve 72 at the nitrogen inlet 74 to the inductor chamber S the predetermined differential pressure of for example 70 mb between the two gas chambers P and S is adjusted by means of a differential pressure regulator 73. The gas from the inductor chamber S is passed through the pump-out pipe 42a to the vacuum pump 43.

The thermomigration device described above and illustrated diagrammatically in FIGS. 1 and 2 requires a reliable differential pressure regulation between the two gas chambers P and S as well as as a result of the gas-tight quartz bell 16 with a thickness of about 10 to 15 mm a slightly larger distance between the susceptor 1 and the inductor 4 which leads to a reduction in the efficiency of the thermomigration device since for this same induced power in the susceptor 1 a greater voltage is required at the inductor 4 and thus more idle power is generated in the inductor oscillatory circuit.

Furthermore a thermal coupling—even if only slight—exists between the upper side of the quartz bell 16 and the susceptor 1. As a result of this the thermal inertia is increased which is noticeably disruptive particularly in the heating-up and cooling down phase of the susceptor 1 primarily through the heat conduction through the helium gas layer between the susceptor 1 and the quartz bell 16.

Different demands are placed on the purity requirements in thermomigration depending on the field of use, i.e. different maximum contamination levels are permissible. By way of example when used in Microsystems technology, such as micro electro mechanical systems (MEMS) process-conditioned heavy metal contaminations are mostly far less disruptive than for structural elements which require high service lives for minority charge carriers such as for example radiation detectors and photodiodes.

If the contamination is not so critical it is possible to omit the separation of the processing and inductor chambers and the technically expensive differential pressure regulating systems connected therewith, whereby however owing to the detachable connection between the susceptor 1 and heat sink 3 the significant advantage remains of being able to make a defined adjustment of small distances between susceptor 1 and heat sink 3, particularly for producing particularly high temperature gradients of several 100 K/cm in silicon.

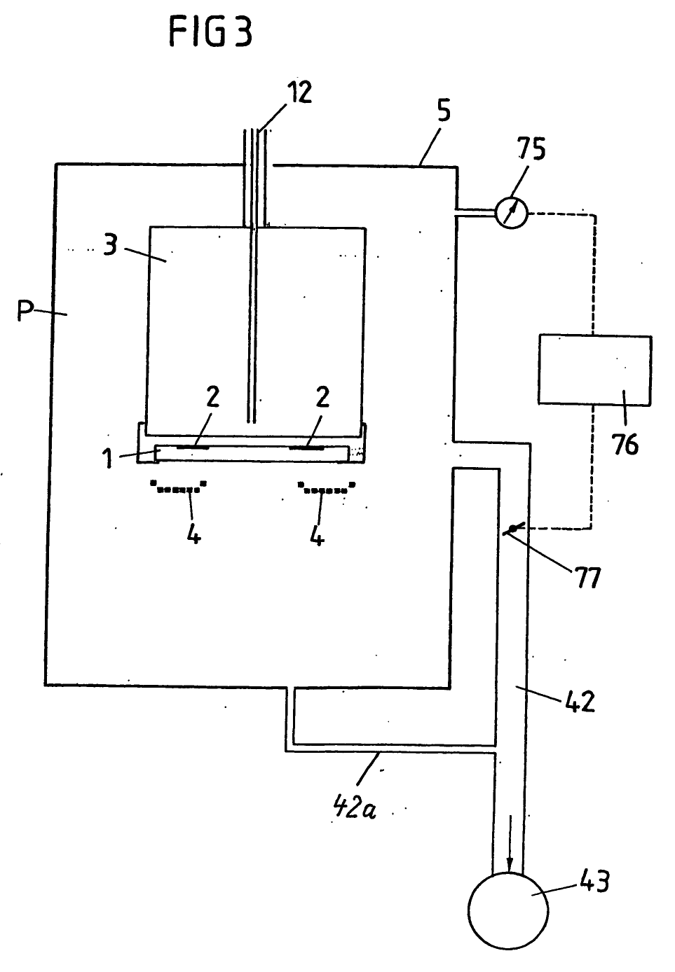

FIG. 3 shows a diagrammatic view of the pressure and gas regulation in a device having a susceptor 1 fixed on the heat sink 3 and a unified gas chamber P incorporated in the recipient 5.

In this arrangement unlike the thermomigration device according to FIGS. 1 and 2 the quartz bell 16 for separating the inductor chamber S containing the inductor 4 from the processing chamber P is omitted so that the inductor 4 is located together with the susceptor 1 in the processing chamber P. Furthermore in this simplified variation of the thermomigration device according to the invention the differential pressure regulating system is omitted with the differential pressure sensor 71 mounted between the processing chamber P and inductor chamber S, the gas regulating valve 72 on the nitrogen inlet 74 to the inductor chamber S, with which the predetermined differential pressure is adjusted between the two gas chambers P and S, and the differential pressure regulator 73 according to FIG. 2.

The gas control remains however with which helium gas is introduced into the processing chamber P through the inlet into the gas duct 12, the gas pressure in the processing chamber P is measured through the gas pressure sensor 75 and the gas pressure in the processing chamber P is adjusted independently of the incoming gas flow by means of the pressure regulator 76 with electronically controlled throttle valve 77 in the pump-out pipe 42.

As will be explained in further detail below, the susceptor 1 can in this simplified embodiment be designed as a simple cylindrical disc since owing to the absence of the quartz bell 16 a small distance can be set from the inductor 4 without problems when connecting the susceptor 1 to the heat sink 3.

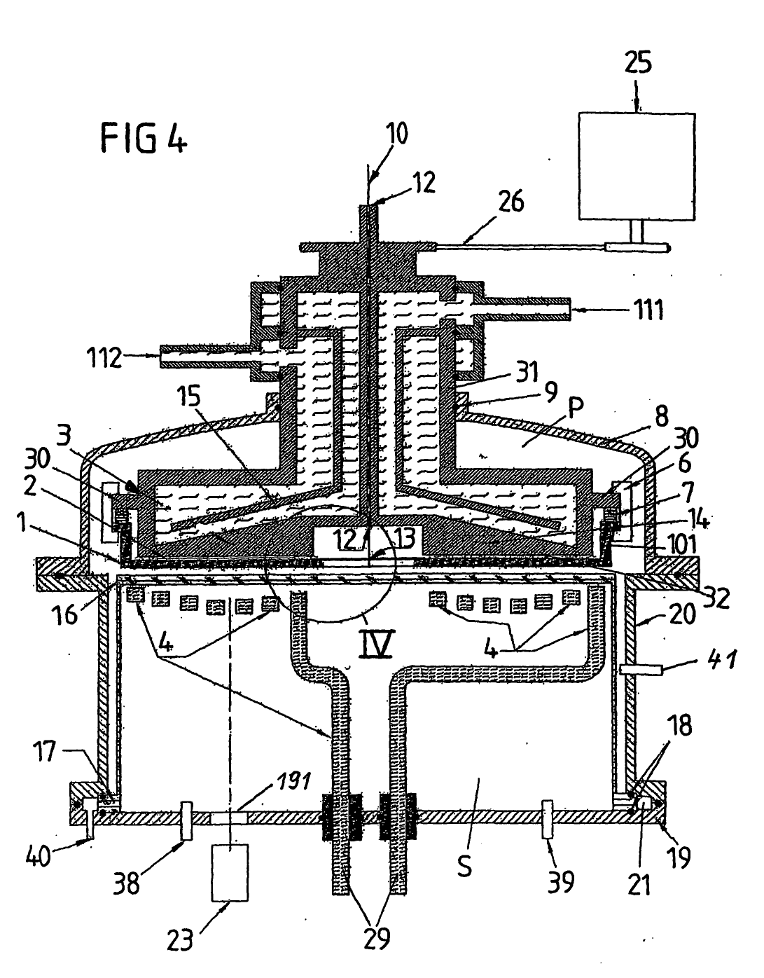

Furthermore it is possible to omit a quartz ring 27 supporting the susceptor 1 according to FIG. 1 so that the susceptor 1 is pressed directly by moulded elements from underneath resiliently towards the heat sink 3. The distance between the susceptor 1 and the heat sink 3 is—as will be explained in further detail below with reference to FIG. 4—set through spacers positioned on the surface of the susceptor and consisting of a high temperature resistant electrically insulating material of low heat conduction and high temperature shock resistance, such as for example quartz glass in the form of cylindrical rods, tubes or flat discs.

FIG. 4 shows a longitudinal section through a thermomigration device with two gas chambers separated from each other, a processing chamber P and an inductor chamber S.

In the processing chamber P there is a susceptor 1 on the surface of which are semiconductor wafers 2 which are to be treated by means of a thermomigration process. The susceptor 1 which preferably consists of graphite is detachably connected through keyed engagement, force locking engagement or a combination of both by its outer edge 101 more particularly through connecting elements 6 in the form of clips, brackets or the like, to socket elements 30 of a heat sink in the form of a water-cooled cooling pot 3 of good heat conductive material, for example aluminium or aluminium alloy. Springs (not shown in FIG. 4) connected to the connecting elements 6 generate a permanently acting force which endeavors to reduce the gap between the heat sink 3 and susceptor 1.

The cooling pot 3 is guided rotatably and vacuum-tight through a bell-shaped upper part 8 of the recipient 5 and rotates during the thermomigration. To load the thermomigration device the upper part 8 can be lifted and pivoted into a loading or unloading position for the semiconductor wafers which are to be treated. The cooling pot 3 is preferably an approximately rotationally symmetrical body whose axis coincides with the axis of rotation or shaft 10 and whose cylinder jacket 31 is guided through a rotational passage 9 in the upper part 8 of the recipient 5.

The distance between the surface of the semiconductor wafer 2 or susceptor 1 and the heat sink 3 or cooling pot base 14 respectively is adjusted and secured with spacers 7 which consist in particular of polished quartz bodies or with spacers 32 of a high temperature resistant electrically insulating material of low heat conduction and high temperature shock resistance, such as for example quartz glass which are placed as cylindrical rods, tubes or flat discs on the surface of the susceptor 1.

The or each semiconductor wafer 2 lies on the surface of the susceptor 1 whereby its position is fixed with suitable elements which can be for example indentations in the susceptor 1 or locator rings.

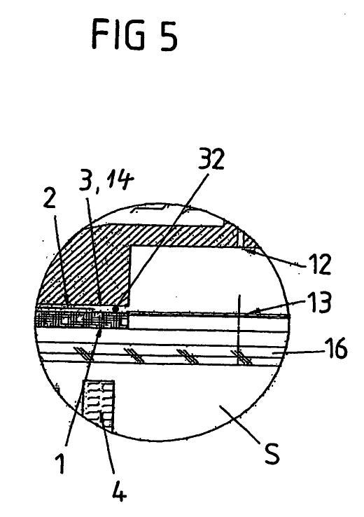

The processing chamber P is surrounded by the recipient 5 which is comprised of the bell-shaped upper part 8, a cylindrical lower part 20 (with pump pipes 40, 41) and a recipient base 19. The upper part 8 has the vacuum-sealed rotational passage 9 for the cooling pot 3 which contains the shaft 10 which is rotatable by means of a drive motor 25 through a transmission element 26 in the form of a chain, gear wheel, toothed belt pulley, belt or the like. As a result of the connection between the cooling pot 3 and the susceptor 1 the latter is likewise entrained in rotation. The rotational axis of the cooling pot 3 formed by the shaft 10 has an inlet into a gas duct 12 for the process gas, preferably helium, as well as inlet and outlets 111, 112 for the cooling medium, preferably water. The process gas duct 12 leads to a recess in the cooling pot 3 which is opposite a disc 13 of quartz glass inlaid in the surface of the susceptor 1 (FIG. 5).

A helium atmosphere with pressures of between 20 and 300 mbar is maintained in the processing chamber P which can be adjusted with a downstream regulation within wide limits independently of the amount of inflowing helium.

Inside the cooling pot 3 the cooling water flows from inside outwards through the cooling pot base 14 and is thereby guided through partition walls 15 whose spacing from the base 14 of the cooling pot reduces increasingly towards the outside. Furthermore the cooling pot base 14 is heavily ribbed and consequently has a large surface area over which the cooling water flows. In addition the severe ribbing of the internal region of the cooling pot causes a high planar moment of inertia so that the cooling pot 3 has in relation to the increased pressure of the cooling fluid a sufficient mechanical strength.

The thickness of the cooling pot base 14 reduces from inside outwards so that the heat resistance of the cooling pot base 14 decreases towards the outside.

In order to reduce the risk of steam evaporating from the surface of the cooling pot the latter is passivated by coating with for example titanium nitride, DLC (diamond-type carbon) or silicon carbide so that there is no risk of impurities on the semiconductor wafer mounted on the susceptor 1.

Underneath the susceptor 1 in the inductor chamber S separated off from the processing chamber P there is an inductor 4 made from a helically wound copper wire which is connected to a controllable MF generator through inductor connecting leads 29. The separation between the processing chamber P and inductor chamber S is achieved by means of a gas-tight quartz bell 16. The individual windings of the helically wound inductor 4 are adjustable in respect of their distance from the susceptor 1 so that by carefully adjusting these distances to the susceptor 1 it is possible to set a radially very homogeneous temperature profile.

The quartz bell 16 ends in a flange ring 17 which is clamped elastically by two elastomer rings 18 between the recipient base 19 and the cylindrical lower part 20 of the recipient 5. A ring gap 21 is left between the bottom 19 of the recipient and the cylindrical lower part 20 of the recipient 5 as well as the sleeve of the flange ring of the quartz bell 16 and is evacuated so that the pressure there remains below the level of the pressures in the inductor chamber S and processing chamber P and a gas exchange cannot take place between the chambers P and S even with a slight contact pressure from the elastomer rings 18.

A gas inlet 38 for the gas is left in the chamber base 19 in the inductor chamber S as well as a pump pipe 39 to the gas outlet.

In the inductor chamber S there is an atmosphere of dry nitrogen with slightly higher pressures than in the processing chamber P which are regulated with known technical means so that the differential pressure to the processing chamber P remains below 100 mbar.

The open inside region of the susceptor 1 is covered by a disc 13 of insulating material more particularly quartz so that the process gas can only flow out through the gap between the semiconductor wafer 2 and cooling pot 3. The base of the cooling pot 3 is drawn back, i.e. away from the inductor 4 above the open centre of the susceptor 1.

Measuring the susceptor temperature is carried out by one or more pyrometers 23 which are directed through windows 191 in the recipient base 19 by using the gaps between the windings of the inductor 4 through the quartz bell 16 to the underneath of the susceptor.

FIG. 5 shows in an enlarged view the sealed arrangement and connection of the susceptor 1 with the semiconductor wafer 2 located thereon both in relation to the cooling pot 3 serving as heat sink and to the inductor 4 mounted in the inductor chamber S and separated by the cover surface of the gastight quartz bell 16. The central bore provided in the susceptor 2 is covered by the electrically insulating disc 13. Furthermore the illustration in FIG. 5 shows the outlet of the gas duct 12 for supplying the process gas helium and the arrangement of the spacers 32 which set the distance between the susceptor 1 and the cooling pot base 14 and thus the heat sink and thus secure the spacing.

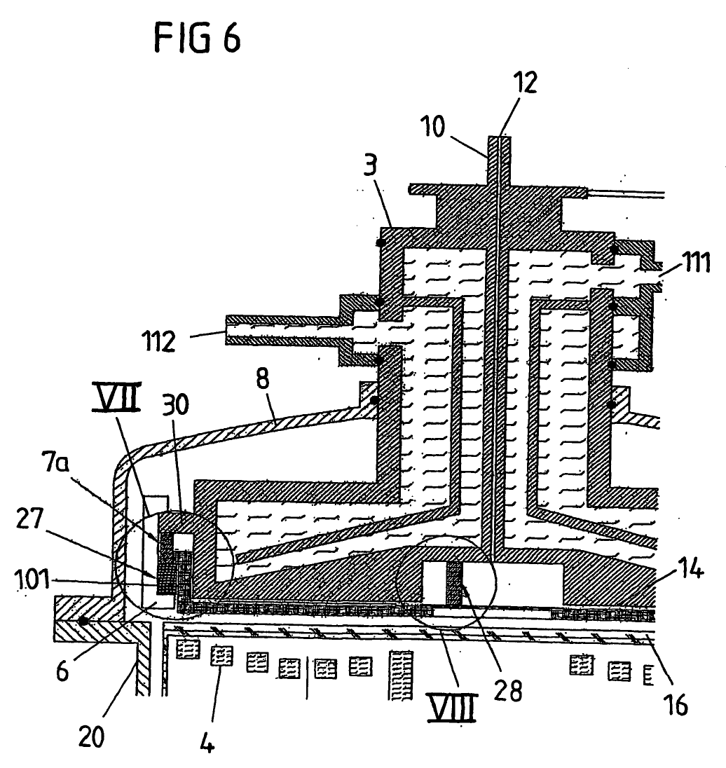

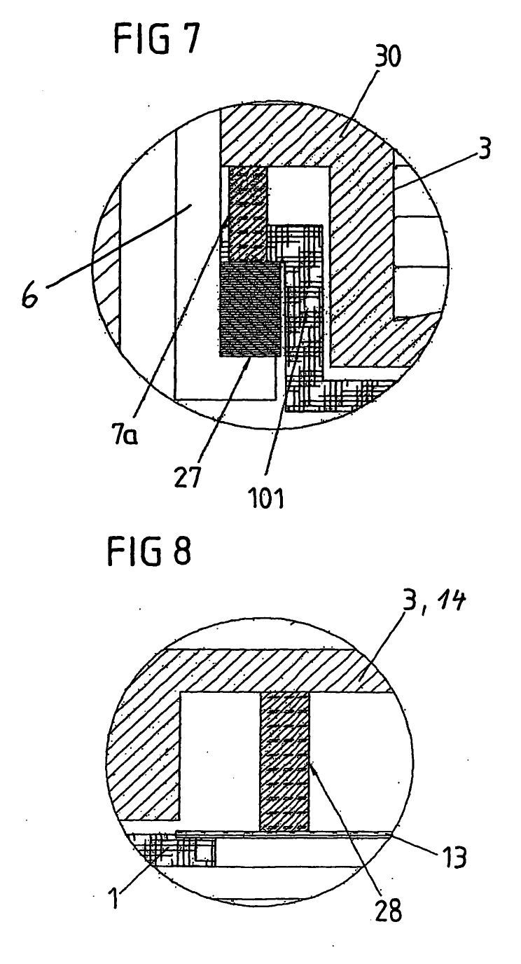

FIG. 6 as well as FIGS. 7 and 8 in an enlarged view of the details VII and VIII according to FIG. 6 show a variation of the thermomigration device according to the invention in which the susceptor 1 rests on a backing support 27, for example a ring of quartz glass on which the connecting elements 6 engage. The susceptor 1 is provided in the connecting region with bores in which spacers 7a are inserted so that the spacers 7a are no longer supported like the spacers 32 on the susceptor 1 but on the backing support 27.

Furthermore the susceptor 1 is supported in the inside region additionally by spacers 28 against the heat sink 3, i.e. the base 14 of the cooling pot so that it can no longer be pressed out from the magnetic field of the inductor 4 against the heat sink 3.

FIG. 7 shows in an enlarged view of the detail VII in FIG. 6 the connection of the susceptor 1 to the socket element 30 of the cooling pot 3. In this embodiment the angled outer edge 101 of the susceptor 1 lies on the backing support 27 in the form of a ring of quartz glass. The connecting elements 6 engage on the backing support 27 and on the socket elements 30. The spacers 7a are inserted in the bores of the susceptor 1 in the connecting region and are supported on the backing support 27 and on the socket element 30 of the heat sink and cooling pot 3 respectively.

FIG. 8 shows in an enlarged view of the detail VIII according to FIG. 6 how the susceptor 1 is supported in its recess area covered by an electrically insulating disc 13 additionally by spacers 28 opposite the heat sink 3.

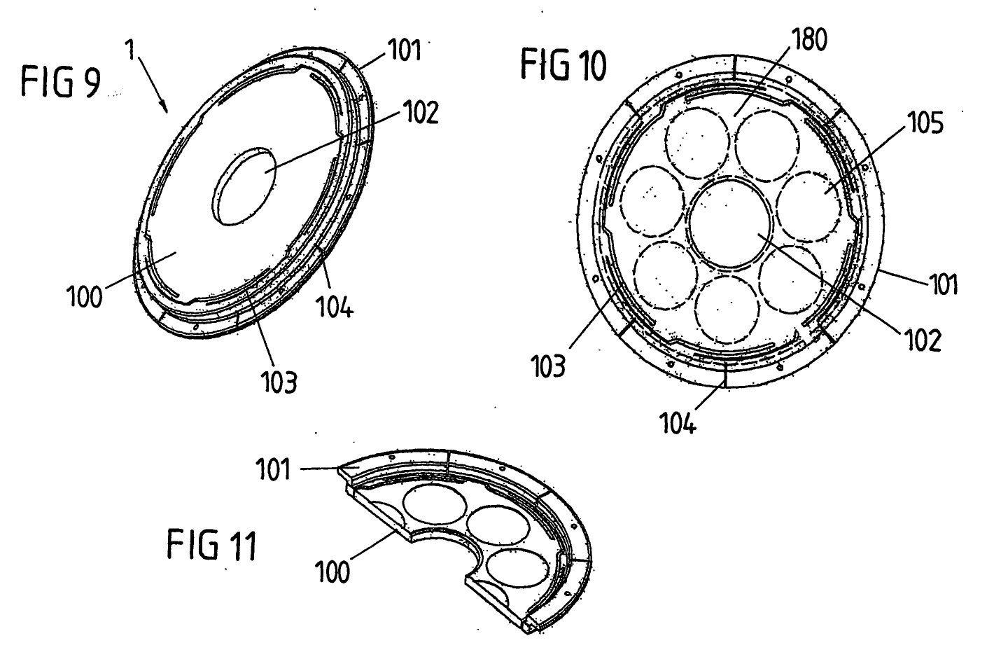

FIGS. 9 to 11 show an embodiment of a susceptor 1 in which FIG. 9 shows a perspective underneath view of the susceptor 1 FIG. 10 shows a plan view of the top of the susceptor 1 and FIG. 11 shows a perspective view of the top side of the susceptor 1 shown in section.

The susceptor 1 has a circular ring shaped inside surface 100 which contains a central bore 102 in the middle. From the circular ring shaped inside surface 100 an angled outer edge 101 protrudes to provide the susceptor 1 with a dish or plate shape. In the outer edge region of the inside surface 100 there are milled areas 103 which restrict the heat flow between the central hot region of the inside face 100 in which the semiconductor wafers are provided, and the colder outside edge 101 and at the same time allow long narrow webs to form which prevent the build up of mechanical tensions as a result of the temperature difference between the contact bearing region of the semiconductor wafers on the inside face 100 and outside edge 101. Additionally in the bent outer edge 101 there are radial slots 104 and in the inside face 100 of the susceptor 1 there are several circular ring shaped recesses 105 to take up the semiconductor wafers.

The thermal separation of the outside edge 101 of the susceptor 1 from the inside face 100 for the semiconductor wafer enables a rapid slope which is advantageous for the thermomigration process as well as a greater homogeneity in the heat distribution since otherwise a considerable proportion of the heat generated in the susceptor would be discharged over the outside edge 101.

The angling of the outside edge 101 serves to increase the distance from the intensely heated inside face 100 to the edge of the susceptor 1 at which the mechanical connecting elements 6 engage for connecting the susceptor 1 to the heat sink or cooling pot 3 so that the fixing elements 6 according to FIGS. 4 and 6 for connecting the susceptor 1 to the heat sink 3 are less thermally stressed and are arranged in a region of the susceptor 1 which lies outside of the magnetic field discharged from the inductor 4 so that the distance between the susceptor 1 and inductor 4 can be minimized.

As an alternative instead of a dish or plate shaped susceptor it is also possible to use a disc like susceptor which is connected to the heat sink by the outer circular disc like edge. This indeed conditions a greater distance to the inductor but enables the production of a very simple shaped susceptor. This configuration of the susceptor is particularly suitable for the simplified embodiment of the thermomigration device according to the invention where the separation of the gas chambers is omitted and thus the quartz bell is left out so that the susceptor can be designed as simple cylindrical disc since by omitting the quartz bell it is possible to set a slight distance to the inductor without problems when connecting the susceptor to the heat sink.

The thermomigration device according to the invention makes it possible to lower the distance between the underneath of the heat sink and the top side of the semiconductor wafer to a measure which only depends on the quality of the surfaces and lies in the region of some few tenths millimeter. Thus even with susceptors having a large diameter of more than 400 mm very small distances can be produced and can be set without canting between the heat sink and susceptor surface which also remain unchanged even during rotation of the susceptor which is a fundamental requirement for the simultaneous treatment of several semiconductor wafers with minimal processing time.

The separation of the gas chambers into a processing chamber holding the semiconductor wafers and an inductor chamber containing the inductor enables optimum operation in the chambers charged with different tasks and functions. Whereas in the processing chamber a gas atmosphere of high heat conductivity and semiconductor purity and thus cleanliness have highest priority, in the inductor chamber it is essentially a question of preventing voltage flashovers. For this reason it is possible to use in the processing chamber helium as process gas with high heat conductivity and only highly pure materials guaranteeing semiconductor purity in the high temperature processes such as quartz glass and graphite for the hot parts, and aluminium and stainless steel for the cold parts. On the other hand in the inductor chamber an inert gas such as nitrogen or SF₆ can be used which has higher voltage flashover resistance.

With maximum output voltages of the MF generator of about 1 kV with these gases and their mixtures in the inductor chamber, pressures of 150 mb are sufficient to prevent voltage flashovers so that it is possible to work with a pressure difference of about 100 mb compatible with the quartz bell in the processing chamber with 50 mb He pressure. It is thereby possible to work with a low mass throughput of helium gas in the processing chamber with a high laminar flow speed required for the semiconductor purity in the process.

1. A device for producing electroconductive passages in a semiconductor wafer by thermomigration by generating a temperature gradient between surfaces of the semiconductor wafer, comprising a semiconductor wafer mounted in a vacuum-sealed recipient containing a heat conductive gas between an inductively heated susceptor serving as a heat source and a heat sink, through which a cooling medium is passed, wherein a conductive doping substance is applied to a surface of the semiconductor wafer facing the heat sink, and wherein the susceptor is connected to the heat sink, the heat sink is mounted together with the susceptor rotatably above an inductor inductively heating the susceptor.

2. The device according to claim 1, wherein the susceptor is pretensioned in the direction of the heat sink and between the heat sink and one of the susceptor or a backing support holding the susceptor are at least one of spacers and distance members.

3. The device according to claim 1, wherein the heat sink comprises a rotationally symmetrical cooling pot with a circular disc shaped or circular ring shaped cooling pot base facing the semiconductor wafer surface, the cooling pot is guided vacuum-sealed and rotatably through an opening in the recipient, and in a part of the cooling pot projecting out from the recipient has at least a cylindrical section through which the cooling medium is supplied and discharged, and a pipe, separated from the coolant, for supplying the heat-conductive gas.

4. The device according to claim 1, wherein the recipient is divided into two gastight separated gas chambers of which one gas chamber comprises a processing chamber holding the susceptor and the other gas chamber comprises an inductor chamber holding the inductor.

5. The device according to claim 4, wherein the processing chamber is filled with or has a flow of heat-conductive gas, which flows in a laminar stream around the surface of the wafer, and the inductor chamber is filled with a gas of high voltage insulation strength or disruptive strength.

6. The device according to claim 5, further comprising different gas pressures controllable in dependence on each other in the processing chamber and in the inductor chamber.

7. The device according to claim 4, wherein the inductor chamber is separated gas-tight from the processing chamber through an electrically insulating vessel connected to a base of the recipient and the heat sink comprises a cooling pot.

8. The device according to claim 7, wherein the recipient comprises an upper part holding the susceptor and a part of the cooling pot, and a lower part surrounding the inductor and/or the electrically insulating vessel containing the inductor, wherein the lower part is connected to the base of the recipient.

9. The device according to claim 8 wherein the upper part connected to the cooling pot and susceptor can be detached, lifted off and pivoted away from the lower part.

10. The device according to claim 1, wherein the heat sink comprises a cooling pot and wherein the temperature of an outside edge of the susceptor is lower than an inside face of the susceptor holding the semiconductor wafer and the outside edge of the susceptor is detachably connected to a socket section of the cooling pot mounted in a marginal region of a cooling pot base.

11. The device according to claim 10, wherein between the outside edge of the susceptor and the inside face of the susceptor holding the semiconductor wafer there is a section which reduces the heat flow from the inside face to the outside edge.

12. The device according to claim 10, wherein the outside edge of the susceptor has a larger vertical distance from the inductor than the inside face holding the semiconductor wafer and is interrupted by radial incisions.

13. The device according to claim 10, wherein the outside edge of the susceptor rests on a backing support.

14. The device according to claim 1, wherein a distance between the surface of the semiconductor wafer and a cooling pot base of the heat sink is 0.1 to 5 mm.

15. The device according to claim 14, wherein between the cooling pot base and an outside edge and/or an inside face of the susceptor there are spacers and/or distance members.

16. The device according to claim 14, wherein between a surface of a backing support of the susceptor and the cooling pot base there are spacers positioned in clearances in an outside edge of the susceptor.

17. The device according to claim 1, further comprising a separating medium between an inside face of the susceptor holding the semiconductor wafer and the semiconductor wafer itself.

18. The device according to claim 17, wherein the separating medium comprises a passivating layer, covering the inside face of the susceptor.

19. The device according to claim 17, wherein the separating medium comprises several thin spacers.

20. The device according to claim 1, wherein in an inside of a cooling pot of the heat sink there are shades, partitions and/or reinforcement ribs and that the cooling medium is introduced into a part of the cooling pot projecting out from the recipient, is guided around a rotational axis of the cooling pot towards a center of a surface of a cooling pot base remote from the susceptor, along this surface to an outer edge of the cooling part and back to the part of the cooling pot projecting out from the recipient where the cooling medium is discharged.

21. The device according to claim 20, wherein on the surface of the cooling pot base remote from the susceptor there are several ducts whose number increases as the radius increases while a cross-section of each individual duct thereby reduces.

22. The device according to claim 1, wherein a thickness of a cooling pot base of the heat sink decreases from inside outwards.

23. The device according to claim 1, wherein an inside face of a cooling pot of the heat sink is covered with a heat conductive passivating layer with a layer thickness of 100 to 500 nm.

24. The device according to claim 1, wherein a vertical spacing between an inside region of a cooling pot base of the heat sink underneath which there is no semiconductor wafer and a plane of the semiconductor wafer surface is greater than the distance between sections of the cooling pot base which are opposite the semiconductor wafer, and the semiconductor wafer surface.

25. The device according to claim 24, wherein the distance lies in the centimeter range.

26. The device according to claim 4, wherein the heat conductive gas is let into the semiconductor wafer chamber controlled through a mass-flow controller so that it flows in a laminar flow around the surface of the semiconductor wafer surface and is removed from the processing chamber through a suction pipe of a vacuum pump whose suction power is adjustable through a throttle valve.

27. The device according to claim 1, wherein the inductor comprises an induction coil and inductor leads are guided through an electrically insulated passage through a recipient base.

28. The device according to claim 1, wherein a shaft forming a rotational axis of a cooling pot of the heat sink and located at right angles to the semiconductor wafer surface is connected in a part of the cooling pot located outside of the recipient to a drive motor through a transmission member or gearing.

29. The device according to claim 1, wherein connecting elements which connect the susceptor to a cooling pot of the heat sink have springs which generate a force drawing the susceptor towards a cooling pot base, and the connecting elements engage on one side on an outer edge and/or a backing support of the susceptor and on a socket section of the cooling pot.

30. The device according to claim 29, wherein the force generated by the springs is taken up through simple shaped bodies or length adjustable structural groups which are located between the cooling pot and the susceptor or backing support of the susceptor and with their length determine the distance between the surface of the semiconductor wafer lying on the susceptor and opposite sections of the cooling pot base.

31. The device according to claim 29, wherein the socket section of the cooling pot is designed as a circumferential ring on a cylinder jacket of the cooling pot.

32. The device according to claim 1, wherein a cooling pot of the heat sink is designed as a complex vessel of aluminium or aluminium compounds.

33. The device according to claim 1, wherein an open inner region of the susceptor designed as a circular ring disc underneath an inlet opening of a duct formed in a cooling pot of the heat sink for the process heat conductive gas is covered by an electrically insulating disc.

34. The device according to claim 4, wherein the pressure in the processing chamber is adjustable between 5 and 1000 mbar through suction power of a vacuum pump which is variable through a throttle valve.

35. The device according to claim 4, wherein a quartz bell surrounding the inductor chamber as a flange ring which is clamped between two elastic rings on an underneath edge of a lower part of the recipient and a recipient base wherein a gap which is formed between the lower part and the flange ring of the quartz bell and which is separated from the processing chamber and the inductor chamber by the elastic rings is evacuated.

36. The device according to claim 1, wherein heat flow between the susceptor and heat sink is measured by a product of a temperature difference of the cooling medium flowing in and out of a cooling pot of the heat sink, multiplied with its volume flow and its specific heat capacity.

37. A device for producing electroconductive passages in a semiconductor wafer by thermomigration by generating a temperature gradient between surfaces of the semiconductor wafer, comprising a vacuum-sealed recipient, an inductively heated susceptor serving as a heat source mounted in the recipient, the susceptor having suitable elements for holding semiconductor wafers, a heat sink having a cooling medium duct for passing a cooling medium, a gas duct for feeding a heat conductive gas into the recipient, wherein the gas duct is arranged to supply the gas between the susceptor and the heat sink, wherein the susceptor is arranged such that the elements face the heat sink and wherein the susceptor is connected to the heat sink, and the heat sink is mounted together with the susceptor rotatably above an inductor inductively heating the susceptor.
